(19) United States
(12) Patent Application Publication
(10) Pub. No.: US 2008/0010197 A1
(43) Pub. Date: Jan. 10, 2008

(54) Enhanced municipal bidding model

(76) Inventor: Christopher M. Scherer, Rutland, VT (US)

Correspondence Address: Kevin M. Farrell;Pierce Atwood, Suite 350, One New Hampshire Avenue, Portsmouth, NH, 03801, US

(21) Appl. No.: 11/483,924

(22) Filed: Jul. 10, 2006

(51) Int. Cl. G06Q 40/00

(52) U.S. Cl. 705/40

(57) ABSTRACT

A system and methods for billing by a hauler for municipal waste collection, including providing a contract between the municipality and the hauler for waste collection services with an invoicing component based on collection data recorded in a residence-specific manner. Further, providing electronic means for identifying a municipal resident responsible for providing waste to be collected by the hauler, and recording, by the hauler, waste collection data in the residence-specific manner. Further still, providing by the hauler, an invoicing for waste collection that includes the invoicing component based on the recorded waste collection data. The instant abstract is neither intended to define the invention disclosed in this specification nor intended to limit the scope of the invention in any way.

### BACKGROUND OF THE INVENTION

1. Field of the Invention

The invention relates to a risk-sharing method for billing a municipality by a hauler for municipal waste collection and sustainability, and more specifically to systems and methods for improving bidding and pricing for municipal waste collection by the hauler.

2. Discussion of Background Information

Bidding and pricing for municipal waste collection by haulers has traditionally been a difficult exercise due to limited available current information used for making an accurate bid and/or pricing for services to be rendered. Typically, the hauler makes a bid on a service contract for waste collection when responding to a Request for Proposal (hereafter RFP) from the municipality. Generally, the RFP is a method for soliciting bids for services by the municipality that does not require a strictly competitive bid. In most municipalities, there are General Municipal Laws requiring political subdivisions that develop a procurement policy identifying the procedures for entrants (i.e., haulers) to follow for procurements. Many of these policies award the RFPs to prospective service providers (i.e., haulers) that have submitted the lowest bid. Generally, this procedure helps ensure the prudent and economical use of public moneys in the best interest of taxpayers. In addition, the above method is intended to facilitate the acquisition of services of maximum quality at the lowest possible cost for the municipality.

Generally, the current practice for making bids by haulers for new municipality waste collection service contracts requires the hauler to gather third party data, organize the third party data and then create a bid using the third party data which is later submitted to the municipality. After submitting the above-mentioned bid, the hauler waits for a reply from the municipality to see if the bid is accepted.

However, third party data often comprises outdated and/or otherwise inaccurate data which, when used as a basis for preparing the bid, may result in an unprofitable bid for the hauler. For example, if the hauler presents an unprofitable bid, the consequence may be providing waste collection services below a profitable margin, i.e., because the third party data under-estimated the amount of waste collection services needed for the municipality. In addition, where erroneous third party data is used as the basis for preparing a bid, it is possible the municipality could be the entity on the wrong side of an unbalanced agreement, if the bid is accepted, thereby adversely affecting the taxpayers. There is a need for a risk-sharing method for pricing waste-hauling services, which incorporates currently available municipal waste collection information when making a bid to the municipality, so as to reduce the potential financial risk to the hauler and municipality.

What is needed therefore is a system and methods by which haulers can bid on municipality waste collection service contracts using current available information to accurately define the waste collection behaviors of municipal residents (i.e., among other things, so as to allow the hauler to submit a profitable bid). Further, the municipality substantially reduces the potential financial risk from having to repeat an expensive RFP process for waste collection service contracts (by failure of the hauler's business) as well as ensure reliable waste collection service to the residents. What is also needed is a system and methods that accurately reflects the amount of municipal waste collection services so as to determine actual costs, rather than the current practice of municipality's paying for services not provided.

After the bid has been submitted to the municipality by the hauler, but prior to formation of a contract, a Municipal RFP Review Committee typically evaluates the hauler's bid and hauler's business. Usually, during this evaluation, the Municipal RFP Review Committee, among other things, determines the capabilities of the hauler and assigns a value (evaluation point), which is later tallied with other evaluation points to determine the most qualified and suitable hauler for municipal waste collection. In particular, the municipal's evaluation of the hauler's capabilities may include review of any other benefits to the municipality the hauler may be able to provide at no extra cost. For example, if the hauler could provide a benefit, such as a customized billing that offers benefits to the municipality and the resident taxpayers, then hauler may receive additional evaluation points resulting in potentially winning the new waste collection service contract.

Thus, what is needed is a system and methods for haulers to provide benefits (i.e., relating to waste collection services) at no extra costs, which are attractive to the municipality and taxpayers.

As previously mentioned, the municipality can be at risk for over-assessing the municipal waste collection needs for residents and paying too much for the waste collection service contract. For example, instead of the municipality paying for waste collection services actually needed, the municipality pays for services as negotiated under the unbalanced agreement. Thus, the municipality is needlessly spending resident's tax paying dollars, when already the municipality has limited funds to address resident municipality financial needs.

What is needed is a system and methods for a municipality to accurately assess the costs associated for a new waste collection service contract, so as reduce the financial risk of over-paying for services not required.

Traditional financing and pricing methods for waste collection services by communities has had little effect on waste generator's behavior in reducing their use of those services and to lower the marginal cost of those services. Further, conventional waste disposal options for municipalities have become increasingly more expensive due to state and Federal governments developing additional and more stringent regulations and guidelines for waste disposal. In particular, these state and Federal initiatives include additional requirements and increasing stringent restrictions on planning, waste disposal siting, design construction, monitoring, and operation for both existing and new landfills and municipal waste combustors. These initiatives also contribute to a parallel increase in the cost of building and operating conventional waste disposal facilities.

With the advent of more stringent waste regulations and higher waste management costs at a time when many landfills are reaching the end of their useful lives and municipalities have increasingly higher budget pressures, municipalities have a renewed interested in finding alternative ways to finance waste collection and reduce costs by reducing the flow of waste to conventional waste disposal facilities.

What is needed is a system and methods for a municipality to mitigate the rising costs and provide equitable revenues as to provide waste generators with incentives to reduce waste generation and use alternative means of waste disposal.

### SUMMARY OF THE INVENTION

The present invention improves a system and methods for risk-sharing for billing by a hauler for municipal waste collection, providing a contract between the municipality and the hauler with an invoicing component based on collection data recorded in a residence-specific manner. Further, providing electronic means for identifying a municipal resident responsible for providing waste to be collected by the hauler and recording, by the hauler, waste collection data in the residence-specific manner. Further still, providing, by the hauler, an invoicing for waste collection that includes the invoicing component based on the recorded waste collection data.

The present invention is directed to a risk-sharing method for the billing by a hauler for municipal waste collection, that includes providing a contract between the municipality and the hauler for waste collection services with an invoicing component based on collection data recorded in a residence-specific manner. Further, providing electronic means for identifying a resident responsible for providing waste to be collected by the hauler and recording, by the hauler, waste collection data in the residence-specific manner. Further still, providing, by the hauler, an invoicing for waste collection that includes the invoicing component based on the recorded waste collection data.

According to an aspect of the invention, the resident can be one of a non-commercial entity, a commercial resident an other entity associated with the municipality.

The invoicing by the hauler for municipal waste collection can be based on recorded waste collection data that can be billed to the municipality, the resident and/or any combination thereof. Further, waste collection data recorded by the hauler, may include one of an invoicing value, a credit and a reward for each resident. Further still, the municipality, the resident and/or any combination thereof can be periodically invoiced by the hauler for municipal waste collection, such that a collection fee is charged for a total amount of waste collection for one or more collection period. It is possible the municipality, the resident and/or any combination thereof can be periodically invoiced by the hauler for municipal waste collection, such that a base collection fee is charged for a limited amount of waste collection, plus one of an additional collection fee is charged for collected waste in excess of aggregate hauling limits and crediting a credit and/or a reward for waste collected under aggregate hauling limits. The municipality, the resident and/or any combination thereof can be periodically invoiced by the hauler for municipal waste collection, such that the invoicing is based on a tier pricing model that charges a collection fee assessed for one or more tier levels of the tier pricing model, plus one of an excess collection fee that is charged for collection of waste exceeding the one or more tier levels, and providing a credit and/or a reward for an amount of waste collected under the one or more tier levels. The invoicing component may include a credit and/or a reward that provides a benefit to each resident based on one of one or more recycling actions and one or more recycling behavior.

According to an aspect of the invention, the electronic means can be selected from a group consisting of one of an RFID system and a GPS system. Further, the RFID system comprises an RFID tag fastened to a container. Further still, the RFID tag contains electronic information relating to a name, an address and other contact information relating to a specific billing plan or billing structure. The RFID tag can be fastened to the container, which is associated with at least one resident.

According to an aspect of the invention, the waste collection data provides for one of an identifying activity data for waste collection in a resident-specific manner to assist in the invoicing component by the hauler. Further, the identifying activity data can include an identification of waste collection services from a group consisting of one of curbside pick-up, mobile household hazardous waste collections, household hazardous waste drop-off facility, transport recycling drop-offs centers and landfills for waste collection in a resident-specific manner to assist in the invoicing component by the hauler. Further still, the identifying activity data may include an identification of waste from a group consisting of solid waste, recycling, bulky waste, white goods, yard waste, electronic waste, other non-commercial entity waste and other commercial waste for waste collection in a resident-specific_{[CMS1]} manner to assist in the invoicing component by the hauler. The identifying activity data can be associated with a geographic location, a weight, a volume, a time and a date for waste collection in a resident-specific manner to assist in the invoicing component by the hauler.

According to a feature of the invention, the waste collection data recorded by the hauler can be associated with preparing at least one bid for municipal waste collection consisting of one of collecting and recycling for the municipality. Further, the waste collection data recorded by the hauler can include other data that includes a third party data relating to one of a historical municipality data, a historical resident data, a government collected data, a non-government collected data, a historical waste collection data and any combination thereof. Further still, the waste collection data is combined with other data so as to provide one or more bids by the hauler for the collection of municipal waste for the municipality. The waste collection data recorded by the hauler can be associated with one or more collection means. Wherein, the collection means can provide data relating to one or more material from a group consisting of one of solid waste, recycling, bulky waste, white goods, yard waste, electronic waste, other non-commercial entity waste and other commercial waste for waste collection in a resident-specific manner to assist in the invoicing component by the hauler. Such that, the identification of the one or more material is associated with one of a geographic location, a weight and a volume for waste collected from each resident of the municipality by the waste hauler. It is possible the waste collection data can provide for a geographic optimization of routing for the one or more collection means for the collecting of municipal waste by the hauler.

According to a feature of the invention, the GPS system includes one of monitoring, locating and providing real time data relating to one of one or more collection means, one or more business associates related with the hauler and one or more driving information such as weather, traffic and other related driving information for routing the one or more collection means.

According to a feature of the invention, wherein the waste collection data provides for each resident's future projected waste collection, based each resident's previous recorded waste collection data. Further, the municipality, the resident and/or any combination thereof can be periodically invoiced by the hauler for municipal waste collection, such that the invoicing by the hauler is transmitted by one of an email, a telephone, a text messaging, a paper mailing, a faxing, an Internet and an electronic medium. It is possible the invoicing can be transmitted together with a report, and/or the invoicing is transmitted separately from the report.

According to a feature of the invention, the report can include the waste collection data, such that the waste collection data has a weight and/or a volume of waste collected by the hauler for each resident. Further, the electronic means includes an RFID system, such that the report provides information from RFID system. Further still, the report can include the waste collection data that has one of a quantity and a quality of the waste collected from each residence whereby the report provides an incentive for economic growth. Wherein, the incentive is a credit and/or a reward that provides a benefit to each resident based on one of one or more recycling actions and one or more recycling behavior.

Another embodiment of the present invention may be directed to a waste hauling service pricing method for billing by a hauler for municipal waste hauling. Further, providing an agreement for municipal waste hauling services and providing electronic means for identifying each resident for collection of waste by the hauler. Further still, recording, by the hauler, pick-up data associated with the collection of waste for each resident of the municipality, and providing, by the hauler, one of an invoicing and a reporting associated with collection of waste based on the pick-up data.

According to an aspect of the invention, the resident can be one of a non-commercial entity, a commercial resident an other entity associated with the municipality. Further, the municipality, the resident and/or any combination thereof can be periodically invoiced by the hauler for municipal waste collection, such that the invoicing and or the reporting by the hauler is transmitted by one of an email, a telephone, a text messaging, a paper mailing, a faxing, an Internet and an electronic medium. Further still, the invoicing of the municipality, the resident and/or any combination thereof, can be based on a collection fee charged for a total amount of waste collection for one or more collection period. It is possible the municipality, the resident and/or any combination thereof can periodically be invoiced by the hauler for municipal waste collection, such that a base collection fee is charged for a limited amount of waste collection, plus one of an additional collection fee that is charged for collected waste in excess of aggregate hauling limits and crediting a credit and/or a reward for waste collected under aggregate hauling limits. The municipality, the resident and/or any combination thereof is periodically invoiced by the hauler for municipal waste collection, such that the invoicing is based on a tier pricing model that charges a collection fee assessed for one or more tier levels of the tier pricing model, plus one of an excess collection fee that is charged for collection of waste exceeding the one or more tier levels, and providing a credit and/or a reward for an amount of waste collected under the one or more tier levels_{[CMS2]}.

According to a feature of the invention, the hauler can use the pick-up data for at least one bid in response to an RFP for municipal waste collection services. Further, the electronic means can include an RFID system having one or more RFID tag attached to one or more container associated with waste collection for each resident of the municipality. Further still, the one or more RFID tag can provide RFID data that is communicated to the pick-up data. The pick-up data may include a load information associated with municipal waste collection for each resident, such that the load relates to the total weight for the waste collection. It is possible the load information is gathered from one or more collection means by the hauler.

According to a feature of the invention, the pick-up data is associated with the reporting so as to include one of a weight and a volume for waste collected from each resident of the municipality. Further, the pick-up data is associated with the reporting so as to include one of a date and a time for waste collected from each participating resident of the municipality. Further still, the electronic means includes a GPS means for one of monitoring, locating and providing real time data relating to one of one or more collection means, one or more business associates related with the hauler and one or more driving information such as weather, traffic and other related driving information for routing the one or more collection means.

Another embodiment of the present invention may be directed to a bidding system for billing by a hauler for municipal waste collection in response to at least one bid associated with the municipality. The bidding system may include a contract for waste collection, providing electronic means for identifying each resident for collection of waste by the hauler. Further, recording, by the hauler, pick-up data associated with the collection of waste for each resident of the municipality. Further, still, providing, by the hauler, one of an invoicing and a reporting associated with collection of waste based on the pick-up data. The bidding system may provide the contract between the municipality and the hauler for waste collection services with the invoicing. Further, the reporting by the hauler can be based on collecting pick-up data associated with waste collection from each participating resident of the municipality. Further still, providing electronic means for identifying the participating resident responsible for providing waste to be collected by the hauler, and recording, by the hauler, the pick-up data for each participating resident of the municipality. Further, providing, by the hauler, one of the invoicing, the reporting and rewarding a reward for waste collection based on the pick-up data.

According to an aspect of the invention, the reward includes providing the participating resident with one of a non-monetary reward and a monetary reward. Further, the invoicing by the hauler for municipal waste collection is based on recorded pick-up data that is billed to the municipality, the participating resident and/or any combination thereof. Further still, the recorded pick-up data by the hauler includes an invoicing value for each participating resident. Further still, the municipality, the participating resident and/or any combination thereof is periodically invoiced by the hauler for municipal waste collection, such that a collection fee is charged for a total amount of waste collection for one or more collection period(s). It is possible the municipality, the participating resident and/or any combination thereof is periodically invoiced by the hauler for municipal waste collection, such that a base collection fee is charged for a limited amount of waste collection, plus one of an additional collection fee is charged for collected waste in excess of aggregate hauling limits and rewarding the reward for waste collected under aggregate hauling limits. Further, the municipality, the participating resident and/or any combination thereof is periodically invoiced by the hauler for municipal waste collection, such that the invoicing is based on a tier pricing model that charges a collection fee assessed for one or more tier levels of the tier pricing model, plus one of an excess collection fee that is charged for collection of waste exceeding the one or more tier levels, and rewarding the reward for an amount of waste collected under the one or more tier levels.

According to an aspect of the invention, the electronic means for identifying the municipal resident is selected from a group consisting of one of an RFID system and a GPS system. Further, the RFID system includes a RFID tag fixed to a container for municipal waste collection, such that each container is associated with each participating residence. Further still, the waste to be hauled by the hauler is selected from a group consisting of one of solid waste, recycling, bulky waste, white goods, yard waste, electronic waste, other non-commercial entity waste and other commercial waste. It is possible the participating resident of the municipality is one of a non-commercial entity, a commercial resident an other entity associated with the municipality.

According to an aspect of the invention, the pickup data is associated with preparing at least one bid for municipal waste collection consisting of one of collecting and recycling for the municipality. Further, the pickup data is associated with preparing at least one bid for municipal waste collection consisting of one of collecting and recycling for the municipality. Further still, the pickup data is associated with one of a weight and a volume for municipal waste collection for the municipality. It is possible the invoicing and the reporting of municipal waste collection of the municipality by the hauler is associated with the pick-up data relating to one of a date, a time, a quantity and a quality of the waste collected from each participating residence. The pick-up data can provide for a percent participation level for all residents of the municipality.

According to an aspect of the invention, the one or more collection means is associated with an identification of materials of the waste collected from each participating residence. Further still, the electronic means includes a GPS means that provides for a geographic optimization routing for one or more collection means for the hauler when collecting municipal waste. It is possible the pick-up data is combined with other data to be used by the hauler for presenting one or more bids to the municipality for waste collection services.

According to an aspect of the invention, the pick-up data includes an identity activity data associated with waste collection selected from a waste group consisting of one of solid waste, recycling, bulky waste, white goods, yard waste, electronic waste, other non-commercial entity waste and other commercial waste. Further, wherein the invoicing and/or the reporting of municipal waste collection is transmitted to the municipality, participating resident and any combination thereof by one of an email, a telephone, a text message, a paper mail, a fax, an Internet and an electronic medium. The reporting includes one of a quantity and a quality of waste collected from each participating residence in the municipality whereby the reporting provides an incentive. Further, the invoicing and/or reporting includes one of one or more hauling activities for the municipal waste collection and one or more contamination listings for each of the one or more hauling activities for the municipal waste collection. The invoicing and/or reporting include one of an accrual of invoices and/or reporting for and credits for one or more collection periods which is transmitted to the municipality, participating resident and any combination thereof.

According to an aspect of the invention, the participating resident includes a group consisting of a senior citizen group, a handicapped group, a back door group, a multi-dwelling group, a spring clean-up group and a fall clean-up group and a curb-side collection group. Further still, the pick-up data includes a first monitoring data having volumes of waste collection for each participating resident for at least one time within a collection period, which is compared with a second monitoring data having volumes of waste collection for each participating resident after the first monitoring data with the collection period.

According to a feature of the invention, the first monitoring data is compared with the second monitoring data, so as to provide an evaluation data for each participating resident. Further, the pick-up data includes one of a non-paying municipality data, a non-paying participating residents data and any combination thereof so as to interrupt waste collection services by the hauler until payment for services rendered is received.

Other exemplary embodiments and advantages of the present invention may be ascertained by reviewing the present disclosure and the accompanying drawing.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The present invention is a risk-sharing method for billing by a waste hauler (hereafter “hauler”) for waste collection services. In particular, the system and methods can provide a hauler to make a profitable bid when responding to a request for proposal (hereafter “RFP”) as well as provide extra benefits (i.e., customized billing and reporting) at no extra costs to a municipality.

The present invention generally includes a system for a risk-sharing method for billing by a hauler for waste collection services. The system provides for a contract between the municipality and the hauler for waste collection services with an invoicing component based on collection data recorded in a residence-specific manner. Further, the system provides for an electronic means for identifying a municipal resident responsible for providing waste to be collected by the hauler and recording, by the hauler, waste collection data in the residence-specific manner. The system provides for invoicing for waste collection, such that the invoicing component is based on the recorded waste collection data.

According to an aspect of the invention, the municipality resident can be represented as one of a non-commercial resident (i.e., a family, as represented by the head of the household), commercial resident (i.e., a corporation, partnership, limited partnership (LP), limited liability partnership (LLP), limited liability company (LLC), limited company (Ltd.), non-profit corporation, sole proprietorship, and/or trust company), and government entities. Further, the term municipality may also be defined as a primarily urban political unit having corporate status and usually powers of self-government, i.e., a municipality of a town, an administration, town office, government represented entity, corporation, non-government entity and any combination thereof.

According to an aspect of the invention, the system may include an invoicing component based on waste collection data collected in a residence-specific manner. Further, the invoicing component by the hauler may provide for an invoicing structure having a “strict schedule pricing” billing structure, a “base-rate plus schedule pricing” billing structure, a “base rate plus tier pricing model” or any combination thereof. In all of the above billing structures, the hauler records into a collection database, waste collected from each resident of the municipality and subsequently uses the recorded waste collection data to assist in determining an invoicing amount to be charge to the municipality and/or resident or any combination thereof.

It is possible the invoicing component may include several factors when determining a billing structure. For example, factors that may be consider are: 1) determining the total number homes requiring waste collection services; 2) determining how many times a truck needs to dump a load for each waste collection route; 3) determining the distance the truck has to travel from start to finish for each waste collection route; 4) determining the distance the truck need to travel for each dump to the disposal site for each waste collection route; 5) determining the amount of driving time a driver takes to complete each waste collection route (including dumps); and 6) determining the distance between homes a long with the activity hours driven by each driver.

According to an aspect of the invention, the above-mentioned “strict schedule pricing” billing structure may include charging the municipality and/or each resident or any combination thereof, for an amount of waste collected, such that the participants that use more of the service, pay more for waste collection and disposal.

The expression “strict pricing schedule” is intended to refer to a schedule of pricing generated by the hauler that includes a comprehensive listing of different types of waste collection services, together with a listing of the price charged in connection with each unit of service. The above-mentioned waste collection services can be selected from a group of waste consisting of solid waste, recycling, bulky waste, white goods, yard waste, electronic waste, other non-commercial entity waste and other commercial waste. Wherein any one of the waste from the above group may include separate invoicing and reporting requirements for the waste collection and the disposal, due to possible state and Federal government regulations and guidelines specified for disposal of the particular waste.

Further, an aspect of strict pricing schedule may include billing different rates for the type of waste collection services provided, such as curbside pick-up, mobile household hazardous waste collections, household hazardous waste drop-off facility, transport recycling drop-offs centers, landfills (construction and demolition debris, yard waste recycling (mulch), white goods processing (large appliance recycling), asbestos disposal, tire disposal), etc.

An aspect of assessing how to charge participants for waste collection when using the strict pricing schedule may include a weight-based pricing or a volume-based pricing and/or some combination of weight-based pricing and volume-based pricing. In particular, the weight-based pricing provides for the hauler weighing the waste collected from the resident and bills for the waste collection service per pound. It is possible the above program can require residents to use standard, municipally supplied cans or allow residents to continue using their own cans. Further, the municipality can consider the type and size of waste collection containers on which to base their rate structure and billing system. In some instances, container type may dictate the rate structure and billing system. In other cases, where a municipality has an established billing system, the strict pricing schedule may be customized to govern the container type and rate structure, so as to replace the existing billing system. By non-limiting example (under the above-mentioned pricing schedule), households can be provided with containers (large cans having a capacity of 64-96 gallons or small or variable cans having a capacity of 32-64 gallons), wherein a different rate can be charged for different size containers. It is possible the hauler could charge households $2.00 for every 64-gallon can of waste set out and $1.25 for every 32-gallon can. Further, the strict pricing schedule can provide for charging the resident an additional fee based on set maximum weight limits for differently sized containers. For example, if a 64-gallon can of waste collected exceeded 50 lbs, or a 32-gallon can of waste collected exceeded 20 lbs, then an additional charge can be charged to the resident by the hauler.

In terms of billing waste collection under the strict pricing schedule, the hauler charges the resident for the total amount of cans collected for a collection period. For example if 2 (64-gallon) cans are set out by the resident and collected by the hauler during the collection period, then the resident is billed $4.00. However, it is possible the resident may be additionally charged for exceeding the maximum weight limit of 50 pounds per 64-gallon can. Likewise, if the municipality had 5,000 residents all participating in waste collection, and the hauler collected 10,000 cans during a collection period, then the municipality would be charged for the collection of 10,000 cans for that collection period. Further, the above municipality may be additionally charged for exceeding the maximum weight limit set per sized can and be charged accordingly. It is possible that the resident and municipality could be charged together, depending on the billing and reporting requirements of the municipality and/or resident or any combination thereof.

However, the strict pricing schedule is not limited to weight-based pricing and/or volume-base pricing (or some combination of weight-based pricing and volume-base pricing), residents may be charged for waste collection services by a per unit basis, for example, appliances (i.e., a refrigerator, washing machine, dyers, etc.) may be charged on a per unit basis. For example, the above pricing schedule may charge $10.00 to the resident for each refrigerator collected by the hauler. Another possible pricing schedule (under the above pricing schedule) may include charging by the type of waste collected (i.e., household hazardous waste, electronic waste, etc.), and/or by the type of waste collected in combination with a weight-base pricing and/or volume-base pricing schedule. Further, in all of the above billing scenarios, the hauler records into a collection database, waste collected from each resident of the municipality and subsequently uses the recorded waste collection data to assist in determining an invoicing amount to be charge to the municipality and/or each resident or any combination thereof.

Thus, some of the aspects of using strict pricing schedule can result in changing resident waste disposal behaviors that reduce some quantities in the waste stream and divert some flows to alternate disposal options. For example, residents will likely give more thought to the waste they throw away, save recyclables to take advantage of possible free recycling programs (and/or recycling reward programs) which can divert waste from the conventional disposal stream. Further, strict pricing scheduling, among other things, conforms to common equity principles that produces strong incentives for residents to reduce waste. In other words, those residents that generate more waste pay more for the additional service. For example, if residents understand that reducing waste disposal (waste collection services), they can reduce their household expenses (or increase the household overall budget), then resident waste disposal behaviors are likely to change.

According to an aspect of the invention, the invoicing component by the hauler may provide for an invoicing structure having the above-mentioned “base-rate plus schedule pricing” billing structure that may include charging the municipality and/or each resident or any combination thereof, for an amount of limited waste collection plus charging an addition fee for waste collection over the aggregate limit by the hauler. In particular, the term “base-rate” may provide for a limited amount of waste collection for the collection period, wherein a base-rate fee is charged for the limited waste collection service rendered by the hauler. Further, the term “plus” may include charging an additional fee (over the base-rate fee) for waste collection over the aggregate limit by the hauler. Further still, in any billing scenarios (discussed below) relating to base-rate plus schedule pricing, the hauler records into a collection database, waste collected from each resident of the municipality and subsequently uses the recorded waste collection data to assist in determining an invoicing amount to be charged to the municipality and/or each resident or any combination thereof.

The term “base-rate plus schedule pricing” is intended to refer to a schedule of pricing generated by the hauler, which includes a comprehensive listing of different types of waste collection services, together with a listing of prices charged in connection with an amount of limited waste collection plus charging an additional fee for waste collection over the aggregate limit. Further, base-rate plus schedule pricing provides for the same waste collection services as the strict pricing schedule, but with the different pricing schedule. As discussed above, the waste collection service can be selected from a group of waste consisting of solid waste, recycling, bulky waste, white goods, yard waste, electronic waste, other non-commercial entity waste and other commercial waste. Wherein any one of the waste from the above-mentioned group can include separate invoicing and reporting requirements for the waste collection and the disposal, due to possible state and Federal government regulations and guidelines specified for disposal of the particular waste.

Further, an aspect of base-rate plus schedule pricing may include billing different base-rates (along with different additional fees charge for waste collection over the aggregate limit) for the type of waste collection services. Again, the above-mentioned waste collection services can include curbside pick-up, mobile household hazardous waste collections, household hazardous waste drop-off facility, transport recycling drop-offs centers, landfills (construction and demolition debris, yard waste recycling (mulch), white goods processing (large appliance recycling), asbestos disposal, tire disposal), etc.

An aspect of assessing how to charge participants for waste collection when using the base-rate plus schedule pricing may include the above-mentioned weight-based pricing or a volume-based pricing and/or some combination of weight-based pricing and volume-based pricing, but with the different pricing schedule. As discussed above, the weight-based pricing provides for the hauler weighing the waste collected from the resident and bills for the waste collection service per pound, wherein the pricing (under base-rate plus schedule pricing) is determined by setting a limited amount of pounds for waste collection, plus charging an additional fee for waste collection exceeding the aggregate limits. Further, like the strict pricing schedule, residents may be required to use standard cans that are municipally supplied or continue using their own cans_{[CMS4]}.

In cases, where a municipality has an established billing system, the base-rate plus schedule pricing can be customized to govern the container type and rate structure, so as to replace the existing billing system. By non-limiting example (under the above-mentioned base-rate plus schedule pricing), households can be provided with containers (large cans having a capacity of 64 gallons or small cans having a capacity of 32 gallons), wherein a different base-rate fee can be charged for the different size containers collected for a period, along with the additional charge for waste collection exceeding the aggregate limit. It is possible the hauler could charge households a base-rate fee of $4.00 for collection of 2 (64-gallon) cans of waste set out for a collection period, with an additional fee charged for waste collection over the aggregate limit, i.e., charging $1.45 per additional 64-gallon can collected. Further, the hauler could charge households a base-rate fee of $2.00 for collection of 2 (32-gallon) cans of waste set out for a collection period, with an additional fee charged for waste collection over the aggregate limit, i.e., charging 90 cents per additional 32-gallon can collected.

Further still, the base-rate plus schedule pricing may optionally provide for a credit and/or a reward for waste collected under the aggregate limit or, in the above example, if the resident did not exceed the 2 (64 gallon) can limit, such that only 1 can (1 can under the aggregate limit) was collected by the hauler during the collection period, then the resident would receive the credit and/or the reward for the 1 (64 gallon) can under the aggregate limit. It is possible, the resident could receive the credit in the form of a coupon (for 1 64 gallon can) for the next waste collection period, or in a form of a credit that provides a benefit to the participating resident. Also, the resident may receive a reward that may be in a non-monetary form (for 1 64 galloncan) that benefits the resident.

However, it is also possible to charge an additional fee if the container exceeds an allotted weight set for the 2 can limit (for either the 64 gallon can or 32 gallon can), wherein an additional fee is charged based on exceeding the aggregate weight limit, i.e., charging $1.45 per additional 64-gallon can weight limit collected or charging 90 cents per additional 32-gallon can weight limit collected. For example, if the 2 (64-gallon) cans of waste collection exceeded 100 lbs for the collection period, then an additional fee would be charged by a per can weight limit, such that if the actual weight of the 2 (64-gallon) cans weighed 145 pounds, then the resident would be charged $1.45 for the additional 45 pounds of waste collection. Further, as discussed above, the base-rate plus schedule pricing may optionally provide for a credit and/or a reward for waste collected under the aggregate limit. For example, if the waste collection of the 64-gallon cans was under the base-rate weight limit by one can (or 50 pounds), then the participating resident may receive a credit and or a reward for waste collection of 1 can or 50 pounds.

Likewise, the municipality can be charged instead of the household, such that if the municipality had 5,000 residents all participating in waste collection, and the hauler collected 10,000 cans (5,000 residents×2 (64 gallon) can limit) during a collection period, the municipality would be charged a base-rate of $20,000 (5,000 residents×$4.00 (2 (64-gallon) can base rate fee) for the collection of 10,000 (64-gallon) cans, plus additionally charged for cans collected over the aggregate limit for that collection period. Further, as discussed above, the base-rate plus schedule pricing may optionally provide for a credit and/or a reward for waste collected under the aggregate limit. For example, if the waste collection of the 64-gallon cans was under the base-rate weight limit by 1,000 cans, then the municipality may receive a credit and or a reward for waste collection of 1,000 cans.

Further, the base-rate fee of $20,000 for the collection of 10,000 (64-gallon) cans can have a base-rate weight limit, such that if wasted collection exceeded the base-rate weight limit, then the municipality would be additionally charged by a per can weight limit (or 50 pounds or $1.45). For example, if the waste collection of the 64-gallon cans was under the base-rate weight limit by 1,000 cans (or 500 pounds), then the participating resident may receive a credit and/or a reward for waste collection of 1,000 cans or 500 pounds_{[CMS5]}.

Further, as discussed above, it is possible the base-rate plus schedule pricing may include a volume-based pricing and/or some combination of weight-based pricing and volume-based pricing, wherein the resident and municipality could be charged together, or separately (or some combination thereof) depending on the billing and reporting requirements of the municipality and/or resident or any combination thereof. Also, as discussed above, in any of the above billing scenarios, the hauler records into a collection database, waste collected from each resident of the municipality and subsequently uses the recorded waste collection data to assist in determining an invoicing amount to be charge to the municipality and/or each resident or any combination thereof.

According to an aspect of the invention, the invoicing component by the hauler may provide for an invoicing structure having the above-mentioned “base-rate plus tier pricing” billing structure that may include charging the municipality and/or each resident or any combination thereof, for an amount of limited waste collection plus charging an additional fee for waste collection over an aggregate tier-pricing limit by the hauler. In particular, the term “base-rate” or “tier-rate” may provide for a limited amount of waste collection for the collection period, wherein a base-rate fee (or tier-rate fee) is charged for the limited waste collection service rendered by the hauler. Further, the term “plus tier-pricing” may include charging an addition fee (over the tier-rate fee) for waste collection over the aggregate limit by the hauler. Further still, in any billing scenarios (discussed below) relating to base-rate plus tier pricing, the hauler records into a collection database, waste collected from each resident of the municipality and subsequently uses the recorded waste collection data to assist in determining an invoicing amount to be charge to the municipality and/or each resident or any combination thereof.

The term “base-rate plus tier pricing” is intended to refer to a schedule of pricing generated by the hauler, which (as presented above for the strict pricing schedule and base-rate plus schedule pricing) includes the comprehensive listing of different types of waste collection services, together with the listing of prices charged in connection with an amount of limited waste collection plus charging an additional fee for waste collection over the aggregate limit. Further, base-rate plus tier pricing provides for the same waste collection services as the above-mentioned strict pricing schedule and base-rate plus schedule pricing, but provides for a different pricing schedule. Also, as discussed above, the waste collection service can be selected from a group of waste consisting of solid waste, recycling, bulky waste, white goods, yard waste, electronic waste, other non-commercial entity waste and other commercial waste. Wherein any one of the waste from the above-mentioned group can include separate invoicing and reporting requirements for the waste collection and the disposal, due to possible state and Federal government regulations and guidelines specified for disposal of the particular waste.

Further, an aspect of base-rate plus tier pricing can include billing at different base-rates (or tier-rates) along with at different additional fee rates or tier-pricing fee-rates for waste collection over the aggregate tier-limit for the type of waste collection services. The above-mentioned waste collection services are the same as the above-mentioned strict pricing schedule and base-rate plus schedule pricing, which include curbside pick-up, mobile household hazardous waste collections, household hazardous waste drop-off facility, transport recycling drop-offs centers, landfills (construction and demolition debris, yard waste recycling (mulch), white goods processing (large appliance recycling), asbestos disposal, tire disposal), etc.

An aspect of assessing how to charge participants for waste collection when using the base-rate plus tier pricing can include the above-mentioned weight-based pricing or a volume-based pricing and/or some combination of weight-based pricing and volume-based pricing, but with the different pricing schedule or tier-pricing schedule. As discussed above, the weight-based pricing provides for the hauler weighing the waste collected from the resident and bills for the waste collection service per pound, wherein the pricing (under base-rate plus schedule pricing) is determined by setting a limited amount of pounds for waste collection, plus charging an additional fee for waste collection exceeding the aggregate limits. Wherein, similar to the above-mentioned strict pricing schedule and base-rate plus schedule pricing, residents may be required to use standard, municipally supplied cans or continue using their own cans. Also, as similar to the above-mentioned strict pricing schedule and base-rate plus schedule pricing, if the municipality already has an established billing system, the base-rate plus tier pricing can be customized to govern the container type and rate structure, so as to replace the existing billing system.

By non-limiting example, assessing how to charge participants for waste collection when using the base-rate plus tier pricing, households can be provided with containers (i.e., 64 gallons, 32 gallons or varied sized containers), wherein a different base-rate fee (or tier-rate fee) can be charged for different size containers collected for a period, along with the additional charge (tier-pricing fee) for waste collection exceeding the aggregate tier-limit. For example, in scenario No. 1, it is possible the hauler could charge households a base-rate fee of $4.00 for collection of 2 (64-gallon) cans of waste set out for a collection period, with an additional fee charged for waste collection over the aggregate tier limit, i.e., charging $1.45 per additional 64-gallon can collected. Further, the hauler could charge households a base-rate fee of $2.00 for collection of 2 (32-gallon) cans of waste set out for a collection period, with an additional fee charged for waste collection over the aggregate limit, i.e., charging 90 cents per additional 32-gallon can collected.

Further still, the base-rate plus tier pricing may optionally provide for a credit and/or a reward for waste collected under the aggregate tier-limit or, in the above example, if the resident did not exceed the 2 (64-gallon) can limit, such that only 1 can (1 can under the aggregate limit) was collected by the hauler during the collection period, then the resident would receive a credit and/or a reward for the 1 (64-gallon) can under the aggregate limit. It is possible, the resident receive the credit in the form of a coupon (for 1 64 gallon can) for the next waste collection period, or in a form of a credit that provides a benefit to the participating resident. Also, the resident may receive a reward that may be in a non-monetary form (for 1 64 gallon can) that benefits the resident.

An aspect of base-rate plus tier pricing may provide for addressing the varied waste collection needs of the municipality by offering multiple billing structure scenarios, wherein each billing structure scenario has a different base-rate plus different tier pricing fee. For example, the hauler may provide the billing structure of scenario No. 1 (above), along with several other scenarios, such as scenario No. 2, scenario No. 3, etc. In particular, scenario No. 2 may include a base-rate fee of $10.00 for collection of 6 (64-gallon) cans of waste set out for a collection period, with an additional tier pricing fee charged for waste collection over the aggregate tier limit, i.e., charging $1.25 per additional 64-gallon can collected. Further, the hauler could charge households an additional base-rate fee of $6.00 for collection of 6 (32 gallon) cans of waste set out for a collection period, with an additional fee charged for waste collection over the aggregate limit, i.e., charging 90 cents per additional 32-gallon can collected. The billing structure scenario is not limited to weight, volume and any combination thereof, but could include, among other things, a billing structure scenario associated with different types of material and/or a different type of waste service collection.

Further, as mentioned above, it is possible that the municipality and the resident could be charged together, depending on the billing and reporting requirements of the municipality and/or resident or any combination thereof. Wherein, as discussed above, the unique billing and reporting needs may be associated with the different types of waste to be hauled, such that the present invention would provide customized billing structures for the municipality and/or resident or any combination thereof. Further, in any of the above billing scenarios, the hauler records into a collection database, waste collected from each resident of the municipality and subsequently uses the recorded waste collection data to assist in determining an invoicing amount to be charge to the municipality and/or each resident or any combination thereof.

According to an aspect of the invention, the system may include an invoicing structure that includes any combination of the “strict schedule pricing”, the “base-rate plus schedule pricing” and the “base rate plus tier pricing”, depending on the billing and reporting needs of the municipality and/or each resident or any combination thereof. Further, some of the aspects of using the above-mentioned invoicing structures can result in changing resident waste disposal behaviors that reduce quantities in the waste stream and divert flows to alternate disposal options. Residents will likely give more thought to the waste they throw away, save recyclables to take advantage of possible free recycling programs (and/or recycling reward programs, providing benefit back to resident based on recycling behavior) which can divert waste from the conventional disposal stream. Furthermore, when residents understand that by reducing waste disposal (waste collection services) they can reduce their household expenses (or increase the household overall budget), then resident waste disposal behaviors are likely to change.

In order to collect data in a residence-specific manner, the present invention includes the system having an electronic means identifying each resident responsible for providing waste to be collected by the hauler that can be used in assisting in invoicing. In particular, the electronic means may include a Radio Frequency Identification (RFID) method, which is an automatic identification method. Automatic identification methods (Auto-ID Data Capture; AIDC) can include RFID tags (also referred as transponders and contactless (IC) tags) as well as bar codes, which rely on storing and remotely retrieving data. An RFID tag is a small object that can be attached to or incorporated into a product, such as a waste container. RFID tags contain silicon chips and antennas to enable them to receive and respond radio-frequency queries from an RFID transceiver. Passive tags require no internal power source, whereas active tags require a power source.

According to an aspect of the invention, the above-mentioned RFID tags may be attached to one or more RFID-labeled container for municipal waste collection, such that each of the one or more RFID-labeled container is associated with each municipal resident. The RFID tag may contain resident-specific electronic information relating to a name_{[CMS6]}, address and other contact information needed for waste collection and billing. Further, the data collected from the RFID tag can be used for invoicing each resident

According to an aspect of the invention, the electronic means may include a GPS system that can record waste collection data of the geographic location of waste collected in a residence specific manner. The GPS system can be used with the above-mentioned RFID system, so as to provide the hauler to invoice for waste collection based on the recorded waste collection data. For example, the hauler records into a collection database, waste collected from each resident of the municipality and subsequently uses the recorded waste collection data to assist in determining an invoicing amount to be charge to the municipality and/or resident or any combination thereof. Wherein, the recorded waste collection data provides the data for the hauler to invoice by any one of the above-mentioned invoicing components, such as “strict schedule pricing” billing structure, a “base-rate plus schedule pricing” billing structure, a “base rate plus tier pricing model” or any combination thereof.

According to an aspect of the invention, the above-mentioned recorded waste collection data collected from the RFID system and/or the GPS system can be used for invoicing for waste collection by the hauler. Wherein, as discussed above, the different types of waste collection services (i.e., curbside pick-up, mobile household hazardous waste collections, household hazardous waste drop-off facility, transport recycling drop-offs centers, landfills (construction and demolition debris, yard waste recycling (mulch), white goods processing (large appliance recycling), asbestos disposal, tire disposal), etc.), that can be included in the invoicing component via the waste collection data by the hauler.

In particular, the recorded waste collection data can be organized into an identifying activity data and a requirement data for waste collection in a resident-specific manner to assist in the invoicing component by the hauler. The identifying activity data can include an identification of waste collection services from a group consisting of one of curbside pick-up, mobile household hazardous waste collections, household hazardous waste drop-off facility, transport recycling drop-offs centers and landfills for waste collection in a resident-specific manner to assist in the invoicing component by the hauler. Further, the identifying activity data can include an identification of waste from a group consisting of solid waste, recycling, bulky waste, white goods, yard waste, electronic waste, other non-commercial entity waste and other commercial waste for waste collection in a resident-specific manner to assist in the invoicing component by the hauler. It is possible the identifying activity data can be associated with a geographic location, a weight, a volume, a time and a date for waste collection in a resident-specific manner to assist in the invoicing component by the hauler. Wherein the identity activity data can be received and/or sent by one of the GPS system, RFID system and a wireless electronic system.

It is also possible, as discussed above, the hauler can invoice participating residents for waste collection from recorded waste collection data that includes a weight-based pricing or a volume-based pricing and/or some combination of weight-based pricing and volume-based pricing. Further, as discussed above, the hauler may provide separate invoicing and reporting for waste from the above-mentioned for the waste collection, based on recorded waste collection data. It is possible, as discussed above, the hauler may invoice for waste collection by the different types of waste collection services (i.e., curbside pick-up, mobile household hazardous waste collections, household hazardous waste drop-off facility, transport recycling drop-offs centers, landfills (construction and demolition debris, yard waste recycling (mulch), white goods processing (large appliance recycling), asbestos disposal, tire disposal), etc.), based on the recorded waste collection data.

According to an aspect of the invention, the above-mentioned recorded waste collection data from the RFID system and/or the GPS system provides the information so the hauler can customize invoicing for waste collection that results in possibly changing resident waste disposal behaviors that reduce some quantities in the waste stream and divert some flows to alternate disposal options. Further, the present invention will likely make residents give more thought to the waste they throw away, save recyclables to take advantage of possible free recycling programs (and/or recycling reward programs) which can divert waste from the conventional disposal stream.

According to another embodiment of the invention, the system can provide waste collection data that includes other data, such as third party data relating to one of a historical municipality data, a historical resident data, a government collected data, a non-government collected data, a general historical waste collection data and any combination thereof. It is possible the system can be used for estimating each resident's future projected waste collection. It is possible the waste collection data can be use to spur an economic benefit for the municipality and/or resident, such as corporate growth, increasing jobs as well as placing money back into the community. For example, the above-mentioned systems may provide information useful for an entity to determine profitability (or not profitability) to establish an operation/facility for manufacture approximate the municipality and/or residents from using the by-products or waste gathered from the waste collection by the hauler.

According to another embodiment of the invention, the system may include an invoicing transmitting medium that can be used by the hauler for billing the municipality and/or residents or any combination thereof. It is possible that the invoicing transmitting medium includes a transmitting group consisting of: email, telephone, text messaging, paper mailing, faxing, Internet, or any type of electronic medium. Further, the transmitting group can used to invoice the municipality and/or residents or any combination thereof. Further still, as already discussed, the municipal resident may include a non-commercial resident, commercial resident and other entity within the municipality, such that it is possible, any of which, can be invoiced via the above noted transmitting group.

According to another embodiment of the invention, the system may include a “report” that can include recorded waste collection data by the hauler that relates to the municipality and/or residents or any combination thereof for waste collection. By non-limiting example, the above-mentioned report may include a summation of the recorded waste collection data relating to waste collection by the hauler for a collection period and/or for two or more periodic periods. Further, the report may include (based on recorded waste collection data) invoicing values, and an ability to monitor waste collection behaviors, so as assist in providing updated reports of waste collection credits for the municipality and/or residents or any combination thereof. It is possible the report may provide for a weight and/or a volume of waste collected by the hauler, associated with the recorded waste collection data from the RFID system and/or an GPS system by the hauler. Further, the report may provide for information relating to the waste collection behaviors of all the users, such that knowing the behaviors of users based on gathered recorded waste collection data, may promote corporate enterprise growth. For example, if the waste collection behaviors were known for the municipality and/or residents, then corporations utilizing collected waste for manufacture or some other product purpose, could be able determine the profitability (or non-profitability) for establishing operations/facilities approximate the municipality and/or residents. Thus, according to the instant invention, the system would be able to promote corporate enterprise growth approximate the municipality and/or residents, resulting in enhancing the economic well being for the municipality, residents and/or any combination thereof.

According to another embodiment of the invention, the report may including invoicing information that can have a transmitting medium group consisting of one of: email, telephone, text messaging, paper mailing, faxing, Internet and any other electronic medium. It is possible the above transmitting medium could be transmitted at real time, wherein the municipality residents can monitor at real time their waste collection behavior and/or services.

The report is not limited to recorded waste collection data gather by the hauler, such that the report can be combined with related municipal billing for the municipality and/or residents or any combination thereof (i.e., water, sewage, taxes, etc.). Further still, the report may be combined with information, such as telephone, electricity, gas, power, cable, insurance, banking, local-state-federal related information, or any information of interest to the municipality and/or residents. It is possible the invoicing and reporting or the municipality and residents or both, via the above transmitting medium, thereof can receive any combination.

According to another embodiment of the invention, the electronic means may include a GPS system can be used for monitoring, locating and providing real time data relating to the collecting means (i.e., trucks, vehicle, etc.) for transporting the collected waste. Further, GPS system can be used for providing a geographic optimization routing for one or more collection means for waste collection by the hauler. The GPS system can be used for monitoring, locating and providing real time data relating to one or more business associates related with the hauler, and/or one or more driving information (i.e., weather, traffic, emergencies, etc.), and/or other related driving information for routing the one or more collection means.

According to the instant invention, the system is not limited to merely to hauler's biding in response to new municipal new waste collection service contracts (RFP's), but the system can be used by an entity bidding on a contract that can benefit from recorded electronic data relating to individual services/items received from a user by the entity, and based on knowing user behaviors, the entity can receive a benefit.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A risk-sharing method for the billing by a hauler for municipal waste collection, the method comprising:
a) providing a contract between the municipality and the hauler for waste collection services with an invoicing component based on collection data recorded in a residence-specific manner;
b) providing electronic means for identifying a resident responsible for providing waste to be collected by the hauler;
c) recording, by the hauler, waste collection data in the residence-specific manner; and
d) providing, by the hauler, an invoicing for waste collection that includes the invoicing component based on the recorded waste collection data.

2. The method of claim 1, wherein the resident is one of a non-commercial entity, a commercial resident and other entity associated with the municipality.

3. The method of claim 1, wherein the invoicing by the hauler for municipal waste collection is based on recorded waste collection data that is billed to the municipality, the resident and/or any combination thereof.

4. The method of claim 1, wherein the waste collection data recorded by the hauler, includes one of an invoicing value, a credit and a reward for each resident.

5. The method of claim 1, wherein the municipality, the resident and/or any combination thereof is periodically invoiced by the hauler for municipal waste collection, such that a collection fee is charged for a total amount of waste collection for one or more collection period.

6. The method of claim 1, wherein the municipality, the resident and/or any combination thereof is periodically invoiced by the hauler for municipal waste collection, such that a base collection fee is charged for a limited amount of waste collection, plus one of an additional collection fee is charged for collected waste in excess of aggregate hauling limits and crediting a credit and/or a reward for waste collected under aggregate hauling limits.

7. The method of claim 1, wherein the municipality, the resident and/or any combination thereof is periodically invoiced by the hauler for municipal waste collection, such that the invoicing is based on a tier pricing model that charges a collection fee assessed for one or more tier levels of the tier pricing model, plus one of an excess collection fee that is charged for collection of waste exceeding the one or more tier levels, and providing a credit and/or a reward for an amount of waste collected under the one or more tier levels.

8. The method of claim 7, wherein the invoicing component includes a credit and/or a reward that provides a benefit to each resident based on one of one or more recycling actions and one or more recycling behavior.

9. The method of claim 1, wherein the electronic means is selected from a group consisting of one of an RFID system and a GPS system.

10. The method of claim 9, wherein the RFID system comprises an RFID tag fastened to a container.

11. The method of claim 10, wherein the RFID tag contains electronic information including a name, a address and other contact information relating to a specific billing plan or billing structure.

12. The method of claim 10, wherein RFID tag fastened to the container is associated with at least one resident.

13. The method of claim 1, wherein the waste collection data provides for one of an identifying activity data for waste collection in a resident-specific manner to assist in the invoicing component by the hauler.

14. The method of claim 12, wherein the identifying activity data includes an identification of waste collection services from a group consisting of one of curbside pick-up, mobile household hazardous waste collections, household hazardous waste drop-off facility, transport recycling drop-offs centers and landfills for waste collection in a resident-specific manner to assist in the invoicing component by the hauler.

15. The method of claim 12, wherein the identifying activity data includes an identification of waste from a group consisting of solid waste, recycling, bulky waste, white goods, yard waste, electronic waste, other non-commercial entity waste and other commercial waste for waste collection in a resident-specific manner to assist in the invoicing component by the hauler.

16. The method of claim 14, wherein the identifying activity data is associated with a geographic location, a weight, a volume, a time and a date for waste collection in a resident-specific manner to assist in the invoicing component by the hauler.

17. The method of claim 1, wherein the waste collection data recorded by the hauler is associated with preparing at least one bid for municipal waste collection consisting of one of collecting and recycling for the municipality.

18. The method of claim 1, wherein the waste collection data recorded by the hauler includes other data.

19. The method of claim 18, wherein the other data includes a third party data relating to one of a historical municipality data, a historical resident data, a government collected data, a non-government collected data, a historical waste collection data and any combination thereof.

20. The method of claim 18, wherein the waste collection data is combined with other data so as to provide one or more bids by the hauler for the collection of municipal waste for the municipality.

21. The method of claim 1, wherein the waste collection data recorded by the hauler is associated with one or more collection means.

22. The method of claim 21, wherein the one or more collection means provides data relating to one or more material from a group consisting of one of solid waste, recycling, bulky waste, white goods, yard waste, electronic waste, other non-commercial entity waste and other commercial waste for waste collection in a resident-specific manner to assist in the invoicing component by the hauler.

23. The method of claim 23, wherein the identification of the one or more material is associated with one of a geographic location, a weight and a volume for waste collected from each resident of the municipality by the waste hauler.

24. The method of claim 9, wherein the waste collection data provides for a geographic optimization routing for the one or more collection means for the collecting of municipal waste by the hauler.

25. The method of claim 9, wherein the GPS system includes one of monitoring, locating and providing real time data relating to one of one or more collection means, one or more business associates related with the hauler and one or more driving information such as weather, traffic and other related driving information for routing the one or more collection means.

26. The method of claim 1, wherein the waste collection data provides for each resident's future projected waste collection, based each resident's previous recorded waste collection data.

27. The method of claim 1, wherein the municipality, the resident and/or any combination thereof is periodically invoiced by the hauler for municipal waste collection, such that the invoicing by the hauler is transmitted by one of an email, a telephone, a text messaging, a paper mailing, a faxing, an Internet and an electronic medium.

28. The method of claim 27, wherein the invoicing is transmitted together with a report.

29. The method of claim 28, wherein the invoicing is transmitted separately from the report.

30. The method of claim 28, wherein the report includes the waste collection data, such that the waste collection data has a weight and/or a volume of waste collected by the hauler for each resident.

31. The method of claim 28, wherein the electronic means includes an RFID system, such that the report provides information from RFID system.

32. The method of claim 28, wherein the report includes the waste collection data that has one of a quantity and a quality of the waste collected from each residence whereby the report provides an incentive for economic growth.

33. The method of claim 32, wherein the incentive is a credit and/or a reward that provides a benefit to each resident based on one of one or more recycling actions and one or more recycling behavior.

34. A waste hauling service pricing method for billing by a hauler for municipal waste hauling, the method comprising:
a) providing an agreement for municipal waste hauling services;
b) providing electronic means for identifying each resident for collection of waste by the hauler;
c) recording, by the hauler, pick-up data associated with the collection of waste for each resident of the municipality; and
d) providing, by the hauler, one of an invoicing and a reporting associated with collection of waste based on the pick-up data.

35. The method of claim 34, wherein the resident is one of a non-commercial entity, a commercial resident and other entity associated with the municipality.

36. The method of claim 34, wherein the municipality, the resident and/or any combination thereof is periodically invoiced by the hauler for municipal waste collection, such that the invoicing and or the reporting by the hauler is transmitted by one of an email, a telephone, a text messaging, a paper mailing, a faxing, an Internet and an electronic medium.

37. The method of claim 34, wherein the invoicing of the municipality, the resident and/or any combination thereof, is based on a collection fee charged for a total amount of waste collection for one or more collection period.

38. The method of claim 34, wherein the municipality, the resident and/or any combination thereof is periodically invoiced by the hauler for municipal waste collection, such that a base collection fee is charged for a limited amount of waste collection, plus one of an additional collection fee that is charged for collected waste in excess of aggregate hauling limits and crediting a credit and/or a reward for waste collected under aggregate hauling limits.

39. The method of claim 34, wherein the municipality, the resident and/or any combination thereof is periodically invoiced by the hauler for municipal waste collection, such that the invoicing is based on a tier pricing model that charges a collection fee assessed for one or more tier levels of the tier pricing model, plus one of an excess collection fee that is charged for collection of waste exceeding the one or more tier levels, and providing a credit and/or a reward for an amount of waste collected under the one or more tier levels.

40. The method of claim 34, wherein the hauler uses the pick-up data for at least one bid in response to an RFP for municipal waste collection services.

41. The method of claim 34, wherein the electronic means includes an RFID system having one or more RFID tag attached to one or more container associated with waste collection for each resident of the municipality.

42. The method of claim 41, wherein the one or more RFID tag provides RFID data that is communicated to the pick-up data.

43. The method of claim 34, wherein the pick-up data includes a load information associated with municipal waste collection for each resident.

44. The method of claim 43, wherein the load information is gathered from one or more collection means by the hauler.

45. The method of claim 34, wherein the pick-up data is associated with the reporting so as to include one of a weight and a volume for waste collected from each resident of the municipality.

46. The method of claim 34, wherein the pick-up data is associated with the reporting so as to include one of a date and a time for waste collected from each participating resident of the municipality.

47. The method of claim 34, wherein the electronic means includes a GPS means for one of monitoring, locating and providing real time data relating to one of one or more collection means, one or more business associates related with the hauler and one or more driving information such as weather, traffic and other related driving information for routing the one or more collection means.

48. A bidding system for billing by a hauler for municipal waste collection in response to at least one bid associated with the municipality, the bidding system including a contract for waste collection, providing electronic means for identifying each resident for collection of waste by the hauler, recording, by the hauler, pick-up data associated with the collection of waste for each resident of the municipality, providing, by the hauler, one of an invoicing and a reporting associated with collection of waste based on the pick-up data, the system comprising:
a) providing the contract between the municipality and the hauler for waste collection services with the invoicing and the reporting by the hauler based on collecting pick-up data associated with waste collection from each participating resident of the municipality;
b) providing electronic means for identifying the participating resident responsible for providing waste to be collected by the hauler;
c) recording, by the hauler, the pick-up data for each participating resident of the municipality; and
d) providing, by the hauler, one of the invoicing, the reporting and rewarding a reward for waste collection based on the pick-up data.

49. The bidding system of claim 48, wherein the reward includes providing the participating resident with one of a non-monetary reward and a monetary reward.

50. The bidding system of claim 48, wherein the invoicing by the hauler for municipal waste collection is based on recorded pick-up data that is billed to the municipality, the participating resident and/or any combination thereof.

51. The bidding system of claim 48, wherein the recorded pick-up data by the hauler, includes an invoicing value for each participating resident.

52. The bidding system of claim 48, wherein the municipality, the participating resident and/or any combination thereof is periodically invoiced by the hauler for municipal waste collection, such that a collection fee is charged for a total amount of waste collection for one or more collection period.

53. The bidding system of claim 48, wherein the municipality, the participating resident and/or any combination thereof is periodically invoiced by the hauler for municipal waste collection, such that a base collection fee is charged for a limited amount of waste collection, plus one of an additional collection fee is charged for collected waste in excess of aggregate hauling limits and rewarding the reward for waste collected under aggregate hauling limits.

54. The bidding system of claim 48, wherein the municipality, the participating resident and/or any combination thereof is periodically invoiced by the hauler for municipal waste collection, such that the invoicing is based on a tier pricing model that charges a collection fee assessed for one or more tier levels of the tier pricing model, plus one of an excess collection fee that is charged for collection of waste exceeding the one or more tier levels, and rewarding the reward for an amount of waste collected under the one or more tier levels.

55. The bidding system of claim 48, wherein the electronic means for identifying the municipal resident is selected from a group consisting of one of an RFID system and an GPS system.

56. The bidding system of claim 55, wherein the RFID system includes a RFID tag fixed to a container for municipal waste collection, such that each container is associated with each participating residence.

57. The bidding system of claim 48, wherein the waste to be hauled by the hauler is selected from a group consisting of one of solid waste, recycling, bulky waste, white goods, yard waste, electronic waste, other non-commercial entity waste and other commercial waste.

58. The bidding system of claim 48, wherein the participating resident of the municipality is one of a non-commercial entity, a commercial resident and other entity associated with the municipality.

59. The bidding system of claim 48, wherein the pickup data is associated with preparing at least one bid for municipal waste collection consisting of one of collecting and recycling for the municipality.

60. The bidding system of claim 48, wherein the pickup data is associated with one of a weight and a volume for municipal waste collection for the municipality.

61. The bidding system of claim 48, wherein the invoicing and the reporting of municipal waste collection of the municipality by the hauler is associated with the pick-up data relating to one of a date, a time, a quantity and a quality of the waste collected from each participating residence.

62. The bidding system of claim 48, wherein the pick-up data provides for a percent participation level for all residents of the municipality.

63. The bidding system of claim 48, wherein the electronic means includes a GPS means that provides for a geographic optimization routing for one or more collection means for the hauler when collecting municipal waste.

64. The bidding system of claim 63, wherein the one or more collection means is associated with an identification of materials of the waste collected from each participating residence.

65. The bidding system of claim 48, wherein the pick-up data is combined with other data to be used by the hauler for presenting one or more bids to the municipality for waste collection services.

66. The bidding system of claim 48, wherein the pick-up data includes an identity activity data associated with waste collection selected from a waste group consisting of one of solid waste, recycling, bulky waste, white goods, yard waste, electronic waste, other non-commercial entity waste and other commercial waste.

67. The bidding system of claim 48, wherein the invoicing and/or the reporting of municipal waste collection is transmitted to the municipality, participating resident and any combination thereof by one of an email, a telephone, a text message, a paper mail, a fax, an Internet and an electronic medium.

68. The bidding system of claim 48, wherein the reporting includes one of a quantity and a quality of waste collected from each participating residence in the municipality whereby the reporting provides an incentive.

69. The bidding system of claim 48, wherein the invoicing and/or reporting includes one of one or more hauling activities for the municipal waste collection and one or more contamination listings for each of the one or more hauling activities for the municipal waste collection.

70. The bidding system of claim 48, wherein the invoicing and/or reporting includes one of an accrual of invoices and/or reporting for and credits for one or more collection periods which is transmitted to the municipality, participating resident and any combination thereof.

71. The bidding system of claim 48, wherein the participating resident includes a group consisting of a senior citizen group, a handicapped group, a back door group, a curbside group, a multi-dwelling group, a spring clean-up group and a fall clean-up group.

72. The bidding system of claim 48, wherein the pick-up data includes a first monitoring data having volumes of waste collection for each participating resident for at least one time within a collection period, which is compared with a second monitoring data having volumes of waste collection for each participating resident after the first monitoring data with the collection period.

73. The bidding system of claim 72, wherein the first monitoring data is compared with the second monitoring data, so as to provide an evaluation data for each participating resident.

74. The bidding system of claim 48, wherein the pick-up data includes one of a non-paying municipality data, a non-paying participating residents data and any combination thereof so as to interrupt waste collection services by the hauler until payment for services rendered is received.
